(19) United States
(12) Patent Application Publication
(10) Pub. No.: US 2026/0031668 A1
(43) Pub. Date: Jan. 29, 2026

(54) MULTI-POLE POLY-PHASE TRANSVERSE FLUX ELECTRIC MACHINE (MOTOR OR GENERATOR) WITH A 3D MAGNETIC FLUX PATH

(71) Applicant: Modal Motors, Inc., Farmington Hills, MI (US)

(72) Inventor: Michael Van Steenburg, Novi, MI (US)

(73) Assignee: Modal Motors, Inc., Farmington Hills, MI (US)

(21) Appl. No.: 19/280,023

(22) Filed: Jul. 24, 2025

Related U.S. Application Data
(60) Provisional application No. 63/675,234, filed on Jul. 24, 2024.

(51) Int. Cl. H02K 1/2798; H02K 1/14; H02K 1/18; H02K 3/42; H02K 16/02

(52) U.S. Cl. CPC H02K 1/2798; H02K 1/145; H02K 1/182; H02K 3/42; H02K 16/02

(57) ABSTRACT

A modular stator assembly for an electric machine comprises a plurality of stator pole modules distributed circumferentially, each module including at least one press-formed phase coil. The machine includes a rotor assembly, which may comprise two or more rotors, having permanent magnets. These magnets are positioned to substantially surround each stator pole, with their magnetic fields oriented either in-plane or through-plane. Energizing a phase coil generates a magnetic field, creating a complete magnetic circuit that flows from the stator poles through the surrounding permanent magnets and, optionally, the back iron. This interaction between the stator's magnetic field and the permanent magnets produces torque, causing rotation of the rotor assembly relative to the stator assembly.

### CROSS-REFERENCE TO RELATED APPLICATIONS APPLICATION

This application claims priority to U.S. Provisional Patent Application No. 63/675,234 filed on Jul. 24, 2024, entitled “MULTI-POLE POLY-PHASE TRANSVERSE FLUX ELECTRIC MACHINE (MOTOR OR GENERATOR) WITH A 3D MAGNETIC FLUX PATH.” This application is hereby incorporated by reference in its entirety.

### TECHNICAL FIELD

The present invention relates to electric machines. More particularly, the present invention pertains to a multi-pole poly-phase transverse flux electric machine (motor or generator) with a 3D magnetic flux path.

### BACKGROUND

Classic electric motors have been around for over 100 years, and they primarily force magnetic flux to flow in a 2D plane within the stacked laminations of the rotor and stator assemblies. The thin laminations which are insulated from one another force the eddy current to stay in the plane of the lamination and thereby minimize the eddy current losses. Modern electric motors are increasingly utilizing 3D flux path materials, generally referred to as Soft Magnetic Composites, that enable the magnetic flux to flow in three-dimensions without the eddy current losses that would occur if the material were a monolithic conventional solid ferromagnetic material.

### SUMMARY

The present disclosure relates to a multi-pole poly-phase transverse flux electric machine (motor or generator) with a 3D magnetic flux path.

In an embodiment of the disclosure, stator pole modules of a modular stator assembly are distributed around the circumference of the stator assembly structure that each contains a press-formed phase coil(s) and are arranged in a specific angular orientation in a manner consistent with a multi-stator pole poly-phase electrical machine. The permanent magnets are placed in an orientation such that they may surround each stator pole substantially on all sides except the interior or alternatively the exterior radius and with their magnetic field direction in the plane of the permanent magnets or alternatively through the plane of the magnets and to the back iron(s). The multi-rotor electric machine may alternatively be comprised of only two rotors. When the single-phase coil(s) is (are) energized, the magnetic field in the stator poles then flows from the stator poles to the surrounding axial permanent magnets, potentially to the radial magnets, alternatively through the respective back iron of the magnets, or the radial back iron(s) only, and back to the stator poles thereby completing a magnetic circuit and producing torque from the rotation caused by the magnetic field of either the stator assembly or permanent magnet rotor assembly.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. When used with a list of items, the phrase “at least one of,” means that different combinations of one or more of the listed items may be used, and only one item in the list may be needed. For example, “at least one of A, B, and C” includes any of the following combinations: A; B; C; A and B; A and C; B and C; and A and B and C. Definitions for certain words and phrases are provided throughout this patent document, those of ordinary skill in the art should understand that in many if not most instances, such definitions apply to prior, as well as future uses of such defined words and phrases.

### BRIEF DESCRIPTION OF THE DRAWINGS

For a more complete understanding of this disclosure and its features, reference is now made to the following description, taken in conjunction with the accompanying drawings in which:

FIG. 1 shows an external view of a motor/generator assembly, according to an outer-runner embodiment of the disclosure;

FIG. 2 shows an external view of a multi-tooth motor/generator stator assembly, according to an embodiment of the disclosure;

FIG. 3 shows a radial cross-section view of a motor/generator rotor assembly, according to an embodiment of the disclosure;

FIG. 4 shows a multi-tooth stator pole module assembly, according to an embodiment of the disclosure;

FIG. 5 shows an exploded view of a multi-tooth stator pole assembly, according to an embodiment of the disclosure;

FIG. 6 shows a press-formed stator coil assembly, according to an embodiment of the disclosure;

FIG. 7 show a stator pole support structure assembly, according to an embodiment of the disclosure;

FIG. 8 shows an exploded view illustration of a multi-tooth rotor assembly, according to an embodiment of the disclosure;

FIG. 9 shows an exploded view of rotor back irons, according to an embodiment of the disclosure;

FIG. 10 shows a cross-section of a motor/generator rotors & stator poles, according to an embodiment of the disclosure; and

FIG. 11 shows a cross-section of the electric machine that shows the magnetic flux path around the stator poles and through the rotor poles.

### DETAILED DESCRIPTION

The figures described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any suitably arranged device or system. Additionally, the drawings are not necessarily drawn to scale.

In one embodiment of the disclosure, a modular stator assembly comprises a plurality of stator pole modules distributed around the circumference of a stator assembly structure. Each stator pole module may contain one or more press-formed phase coils, or alternatively, wound coils, hairpin coils, or other coil types suitable for use in electrical machines. These modules are arranged in a specific angular orientation to facilitate the operation of a multi-stator pole electrical machine, but other orientations and arrangements are possible.

The permanent magnets of the rotor assembly are positioned in an orientation such that they substantially surround each stator pole, except for the interior or, alternatively, the exterior radius of the stator pole. The magnets may be arranged in a Halbach array configuration, or other configurations such as alternating polarity or radial magnetization, to optimize the interaction between the stator poles and the permanent magnets, thus enhancing the efficiency of the motor/generator. The magnetic field direction of the permanent magnets is typically aligned with their major axis plane, but other orientations are also possible.

The disclosed electric machine is not limited to a specific number of rotors. It may be a multi-rotor machine as shown, or it may have only two rotors, or even a single rotor. Additionally, the invention contemplates the use of both axial and radial flux magnets, or either type alone, to create a 3D flux path that maximizes the utilization of the magnetic field strength from the permanent magnets. The axial flux magnets have their magnetic field direction transverse to the rotor rotation axis and perpendicular to their axial surface area, while the radial magnets have their flux direction parallel to the rotation axis. This arrangement, combined with the plurality of permanent magnet surface areas perpendicular to the face of the modular stator poles, enables an effectively greater magnetic flux density within a constrained volume of the electric machine.

When the single-phase or multi-phase coils of the stator pole modules are energized, a magnetic field is generated in the stator poles. This magnetic field then flows from the stator poles to the surrounding permanent magnets, potentially passing through both axial and radial flux magnets if present. The magnetic field continues through the respective back iron of the magnets, or only the radial back iron(s) if axial flux magnets are not used, and then returns to the stator poles, completing the magnetic circuit. This interaction between the magnetic fields of the stator assembly and the permanent magnet rotor assembly produces torque, resulting in the rotation of either the stator assembly or the rotor assembly, depending on the configuration of the electric machine.

As described more fully below, the magnetic flux flow can be either perpendicular to the stator assembly pole faces or parallel to the stator pole faces.

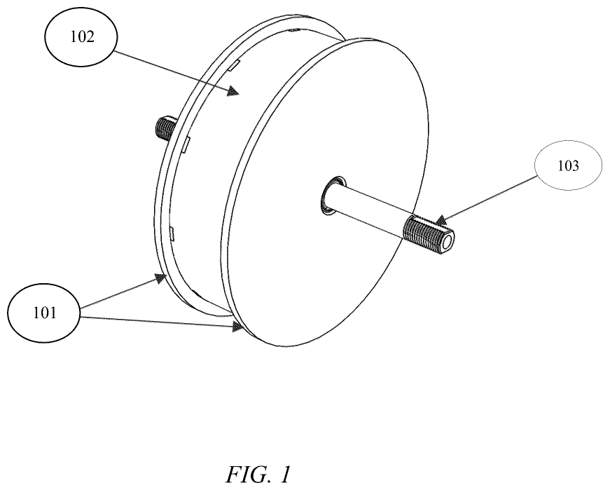

FIG. 1 is an external view of the motor/generator assembly in an embodiment of the disclosure. This view shows a complete three rotor motor assembly. In this particular configuration, the motor/generator assembly is configured as an outer-runner wheel hub motor. The assembly includes an axial rotor housing 101, an outer rotor back iron 102, and a shaft 103. The outer-runner configuration provides output power to the rotating outer housing 101 with the center shaft 103 fixed. The motor/generator assembly may also be configured as an inner-runner unit with the center shaft rotating to provide output power and torque while the housing is fixed.

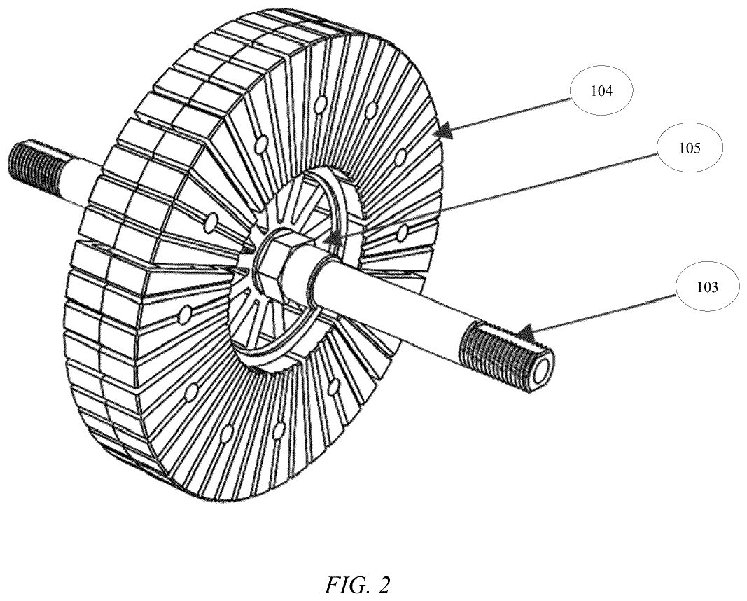

FIG. 2 depicts a multi-tooth stator assembly 104 designed for integration into the motor/generator assembly. In this embodiment, the stator assembly 104 is configured for an outer-runner wheel hub motor, where the stator teeth are fixed relative to the central shaft 103 and interact with the rotating rotor mounted to the outer housing. Also shown is a stator support spider 105. The stator assembly 104 is adaptable to various motor/generator configurations and is not limited to the specific embodiment shown.

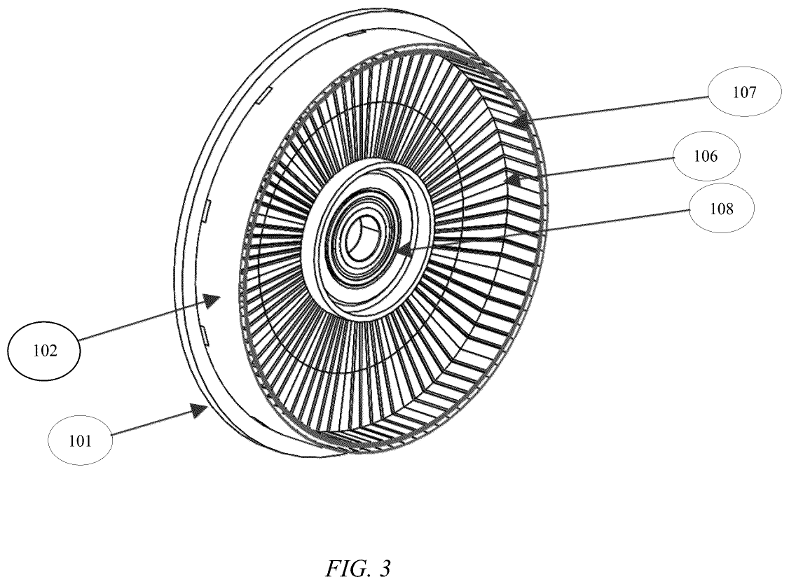

FIG. 3 shows a radial cross-section of an exemplary rotor assembly designed for integration into a motor/generator assembly. In this embodiment, the rotor assembly is configured for an outer-runner wheel hub motor, but the disclosed design is not limited to this application. The illustrated rotor assembly features axial magnets 106 and outer radial magnets 107, which may, for example, be permanent magnets embedded within a laminated core structure. This configuration promotes efficient power generation and torque production. However, other magnet configurations, such as surface-mounted or interior permanent magnet designs, may also be employed. The illustrated rotor assembly is further designed to rotate with the outer housing 101, interacting with a stationary stator (not shown) to produce power and torque. To facilitate such a relative rotation, toro support bearings 108 are shown. While a specific configuration is shown, it is contemplated that the rotor assembly could be adapted for use in inner-runner configurations or other types of motor/generator systems.

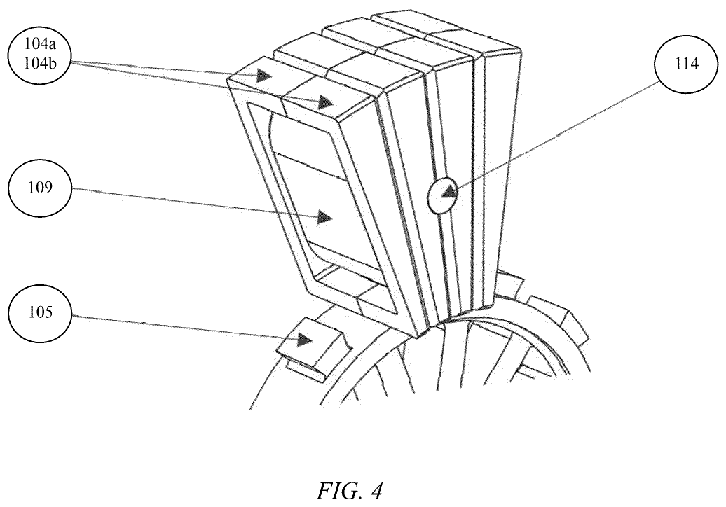

FIG. 4 depicts an external view of a multi-tooth stator pole module assembly, which forms part of the larger stator assembly shown in FIG. 2. The module assembly comprises a plurality of stator poles, each having multiple teeth for interaction with the rotor. The stator poles are shown with stator pole halves 104A, 104b. Also seen is a stator pole retainer 114 and a discrete stator coil 109. While the illustrated embodiment shows a specific tooth configuration, alternative tooth profiles, numbers of teeth, and arrangements are within the scope of the present invention.

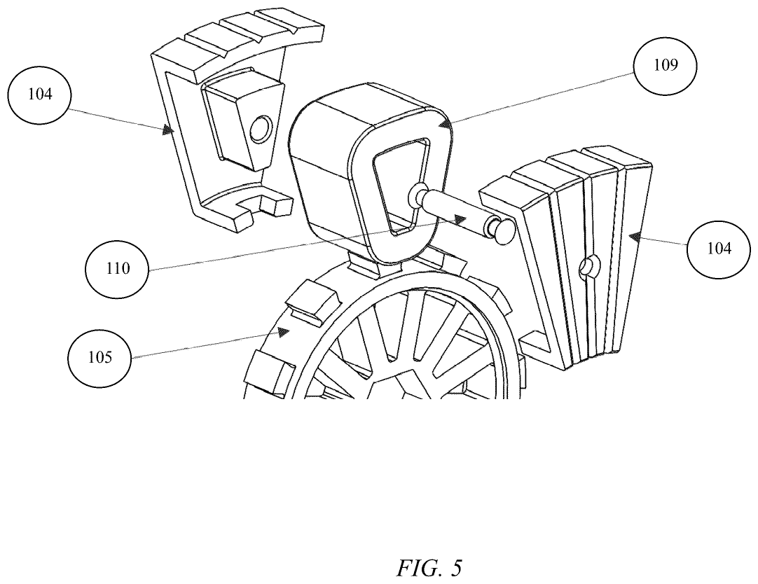

FIG. 5 provides a view of inner components, including the stator pole support structure assembly, a set of multi-tooth stator pole halves, a pressed coil, and optional cooling plate(s). Additional components, such as insulation layers, thermal interface materials, or vibration-damping elements, may also be included.

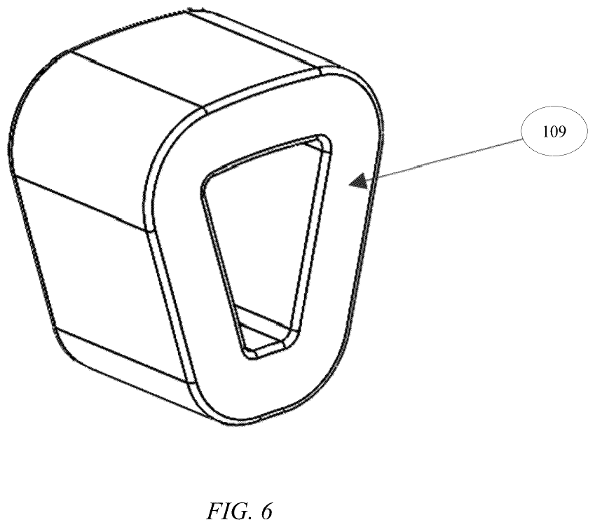

FIG. 6 illustrates a press-formed stator coil 109, an integral component of the multi-tooth stator pole module assembly shown in FIG. 4. The illustrated coil design is exemplary and not limiting. Alternative coil designs, including but not limited to wound coils, hairpin coils, or insert coils, may be employed within the scope of the present disclosure.

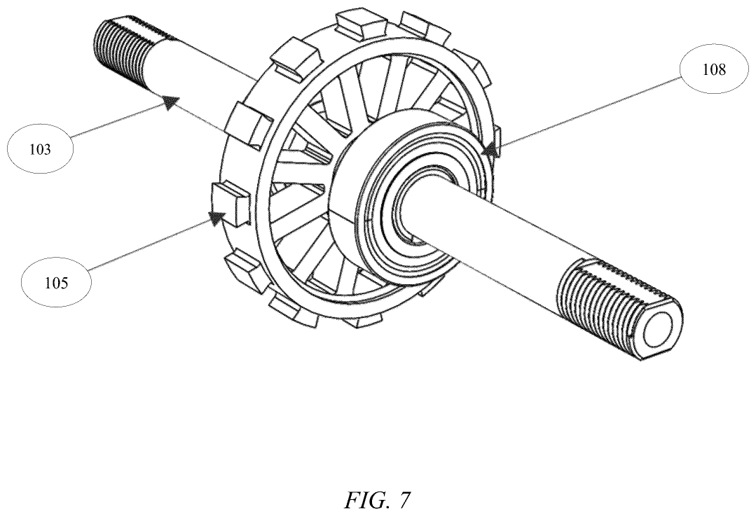

FIG. 7 depicts the stator pole support structure assembly, including its axle shaft 103, bearings 108, and stator support structure 105. This assembly may optionally incorporate an integral phase coil printed circuit board (PCB) with or without sensors for functions like motor temperature and rotor position detection. The PCB, not shown in FIG. 7, may utilize an integral heat sink and connect all phase coils in a poly-phase arrangement. Alternative connection schemes, such as star or delta configurations, are also contemplated.

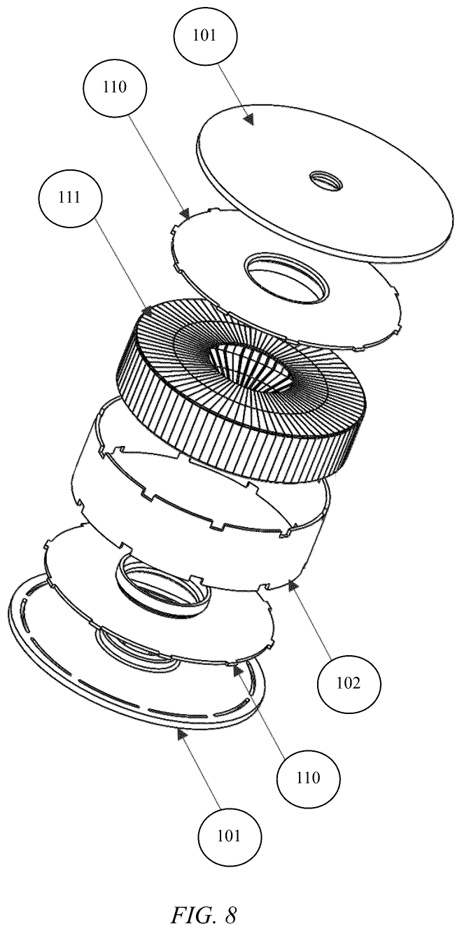

FIG. 8 presents an exploded view of the multi-tooth rotor assembly from FIG. 3, revealing its interlocking segmented multi-tooth rotor magnet poles 111, outer rotor back irons 102, axial rotor back irons 110, and modular rotor housing 101. While the illustrated embodiment shows specific magnet and back iron configurations, alternative configurations are within the scope of the present invention. The segmented permanent magnet poles may be arranged in a Halbach Array configuration, but other arrangements, such as alternating polarity or radial magnetization, are also possible. Additionally, while the back irons are shown as interlocking segments, alternative back iron structures, such as a single-piece back iron or a back iron with a different segment configuration, may be employed.

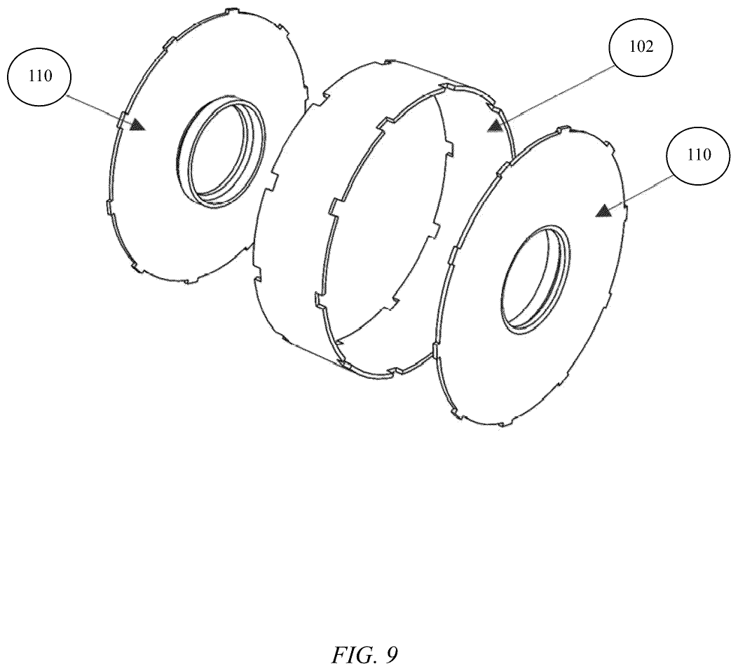

FIG. 9 illustrates the rotor back irons 102, 110 shown in FIG. 8, which may be constructed from a coil of thin laminated steel, wound or comprising concentric hoops, to minimize losses. Alternatively, the back irons 102, 110 may be made of thin soft magnetic composite material, solid ferrous material, or combinations of these materials. Other suitable materials may also be used, such as amorphous metals or nanocrystalline materials.

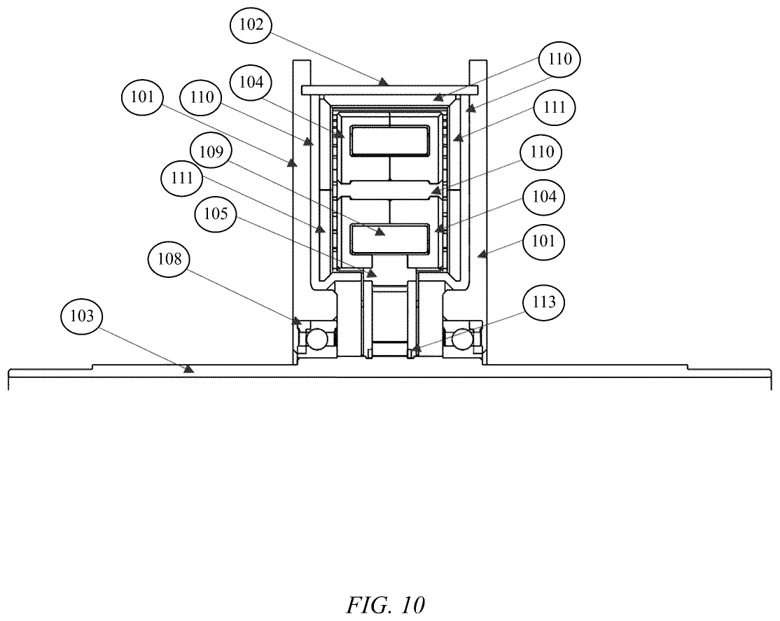

FIG. 10 shows a cross-section of the motor assembly, illustrating a possible general arrangement of components in an outer-runner motor/generator configuration. In addition to previously described structures, a stator spider retention clip 113 is shown. The specific arrangement shown is illustrative and not limiting. Alternative arrangements, such as inner-runner configurations, axial flux configurations, or transverse flux configurations, are also within the scope of the present disclosure.

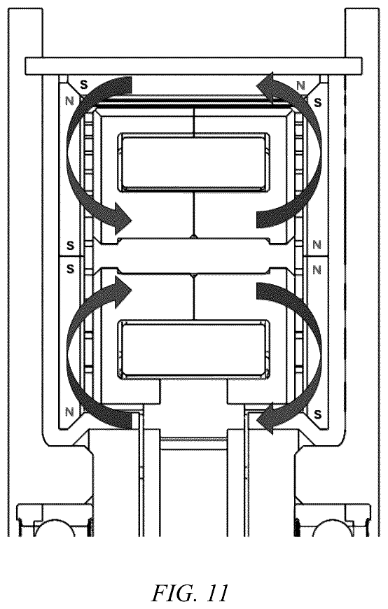

FIG. 11 shows one method of magnetic flux flow with reference to FIG. 11. Yet other configurations may also be utilized.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A multi-rotor electric machine with a 3D magnetic flux path that is comprised of a series of modular stator poles and corresponding modular rotor poles that are arranged circumferentially in a configuration such that enables a poly-phase electrical machine commonly known as a motor or generator to generate rotary motion of the rotor assembly.

2. The electric machine of claim 1, wherein the configuration may be either an inner runner (shaft driven) configuration or an outer runner (wheel or hub motor) configuration.

3. The electric machine of claim 1, wherein the number of rotors is greater than one but less than four.

4. The electric machine of claim 1, wherein the major axis of the phase coils of the stator pole modules are oriented parallel to the radial axis of the electric machine.

5. The electric machine of claim 1, wherein the coils may be made of press-formed, wound, laser cut or PCB coil configurations.

6. The electric machine of claim 1, wherein the stator poles are made of a 3D flux path ferrous material that partially or fully encapsulate the phase coil.

7. The electric machine of claim 1, wherein the stator pole assemblies or rotor pole assemblies are separated by a diamagnetic material.

8. The electric machine of claim 1, wherein the stator poles have a multi-tooth configuration that enables greater torque to be produced by the stator pole.

9. The electric machine of claim 1, wherein the stator pole modules may contain integral cooling plates in direct thermal contact with the phase coil.

10. The electric machine of claim 1, wherein the stator pole halves are held together by a stainless-steel pin that is formed to maintain a constant clamping force on the stator pole halves which also clamps the stator poles to the stator pole support structure. The stainless-steel pin may also be made of an alternative material that is magnetically transparent.

11. The electric machine of claim 1, wherein the stator pole modules may be fully potted inside and between stator pole modules with thermally conductive encapsulant material.

12. The electric machine of claim 1, wherein the stator pole modules may contain a thermocouple or other electronic sensor.

13. The electric machine of claim 1, wherein the stator pole modules may contain a fluid inlet and outlet to form a flood-cooled phase coil configuration.

14. The electric machine of claim 1, wherein the stator pole support structure may be made of stainless-steel, or other magnetically transparent material, and may contain interior cooling channels or tubes that enable cooling fluid to be transmitted from the exterior of the electric machine directly to the stator pole modules and back out of the electric machine.

15. The electric machine of claim 1, wherein the stator pole support structure may contain a PCB that directs current and voltage to the phase coils that are connected directly to the perimeter of the PCB. The PCB may contain other electronic sensors for monitoring or control of the phase coils and the PCB may utilize the stator pole support structure as a heat sink for the PCB phase leads or integral electronic components.

16. The electric machine of claim 1, wherein the rotor assembly may be comprised of two or more rotors, but less than four, that are arranged magnetically to complement one another to produce power and torque.

17. The electric machine of claim 1, wherein a rotor pole may be made of an array of segmented magnets.

18. The electric machine of claim 1, wherein a rotor pole may be made of an array of segmented magnets to form a Halbach Array.

19. The electric machine of claim 1, wherein a rotor pole may be made of an array of Halbach Arrays.

20. The electric machine of claim 1, wherein the rotor pole may consist of a multi-tooth pole configuration.

21. The electric machine of claim 1, wherein the rotor poles interlock with each other structurally to mutually support one another to resist against movement towards the stator pole as a result of the electromagnetic forces.

22. The electric machine of claim 1, wherein the rotor back iron is made of a wound coil of ferrous material that reduces eddy current losses as the magnetic flux flows through the back iron.

23. The electric machine of claim 1, wherein the rotor back iron is made of concentrically stacked ferrous rings that reduce the eddy current losses as the magnetic flux flows through the back iron.

24. The electric machine of claim 1, wherein the rotor back irons are tabbed to interlock with the rotor housing and one another to aid in alignment of the multiple rotors during assembly.

25. The electric machine of claim 1, wherein the rotor poles may be of a non-permanent magnet material.

26. The electric machine of claim 1, wherein the radial and/or axial permanent magnet rotor(s) do(es) not require a back iron.
